(19) United States
(12) Patent Application Publication
(10) Pub. No.: US 2023/0025122 A1
(43) Pub. Date: Jan. 26, 2023

(54) SECONDARY BATTERY

(71) Applicant: MURATA MANUFACTURING CO., LTD., Kyoto (JP)

(72) Inventors: Takatoshi MUNAOKA, Kyoto (JP); Masahiro MIYAMOTO, Kyoto (JP); Tomomi SAKUMA, Kyoto (JP); Takuju HASHIMOTO, Kyoto (JP)

(21) Appl. No.: 17/955,830

(22) Filed: Sep. 29, 2022

Related U.S. Application Data
(63) Continuation of application No. PCT/JP2020/042561, filed on Nov. 16, 2020.

(30) Foreign Application Priority Data
Mar. 31, 2020 (JP) 2020-063604

(51) Int. Cl. H01M 4/525; H01M 10/0525; H01M 10/0569; H01M 10/0587

(52) U.S. Cl. CPC H01M 4/525; H01M 10/0525; H01M 10/0569; H01M 10/0587; H01M 2004/027

(57) ABSTRACT

A secondary battery includes a positive electrode, a negative electrode, and an electrolytic solution. The positive electrode includes a lithium-nickel composite oxide. The negative electrode includes a lithium-titanium composite oxide. The electrolytic solution includes a dinitrile compound and a carboxylic acid ester. A ratio of a capacity per unit area of the positive electrode to a capacity per unit area of the negative electrode is greater than or equal to 100% and less than or equal to 120%. A ratio of a number of moles of the dinitrile compound to a number of moles of the carboxylic acid ester is greater than or equal to 1% and less than or equal to 4%.

### CROSS REFERENCE TO RELATED APPLICATIONS

The present application is a continuation of PCT patent application no. PCT/JP2020/042561, filed on Nov. 16, 2020, which claims priority to Japanese patent application no. JP2020-063604, filed on Mar. 31, 2020, the entire contents of which are herein incorporate by reference.

### BACKGROUND

The present application relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

For example, to improve a characteristic such as a low-temperature output characteristic, an operating voltage of a negative electrode is 1.2 V or higher versus a lithium reference electrode, and an electrolytic solution includes a carboxylic acid ester such as methyl acetate. To suppress swelling of a secondary battery, a negative electrode includes spinel lithium titanate, and an electrolytic solution includes ethyl acetate. To improve an electrochemical characteristic in a wide temperature range, a negative electrode includes lithium titanate as a negative electrode active material, and an electrolytic solution includes an isocyanate compound. To reduce gas generation in high-temperature use, a negative electrode includes a titanium oxide, and an electrolytic solution includes a dinitrile compound.

### SUMMARY

The present application relates to a secondary battery.

Although consideration has been given in various ways in relation to performance improvement of a secondary battery, a swelling characteristic and a charge characteristic as well as an energy density are not sufficient yet, and there is still room for improvement.

The present technology has been made in view of such an issue, and thus relates to providing a secondary battery that is able to obtain a superior swelling characteristic and a superior charge characteristic while securing an energy density according to an embodiment.

A secondary battery according to an embodiment includes a positive electrode, a negative electrode, and an electrolytic solution. The positive electrode includes a lithium-nickel composite oxide. The negative electrode includes a lithium-titanium composite oxide. The electrolytic solution includes a dinitrile compound and a carboxylic acid ester. A ratio of a capacity per unit area of the positive electrode to a capacity per unit area of the negative electrode is greater than or equal to 100% and less than or equal to 120%. A ratio of a number of moles of the dinitrile compound to a number of moles of the carboxylic acid ester is greater than or equal to 1% and less than or equal to 4%.

The term “lithium-nickel composite oxide” described above is a generic term for an oxide including lithium and nickel as constituent elements. The term “lithium-titanium composite oxide” described above is a generic term for an oxide including lithium and titanium as constituent elements. Details of each of the lithium-nickel composite oxide and the lithium-titanium composite oxide will be described later.

According to the secondary battery of an embodiment, the positive electrode includes the lithium-nickel composite oxide, the negative electrode includes the lithium-titanium composite oxide, and the electrolytic solution includes the dinitrile compound and the carboxylic acid ester. In addition, the ratio related to the capacity of the positive electrode and the capacity of the negative electrode is within the above-described range, and the ratio related to the number of moles of the dinitrile compound and the number of moles of the carboxylic acid ester is within the above-described range. This makes it possible to obtain a superior swelling characteristic and a superior charge characteristic while securing an energy density.

Note that effects of the present technology are not necessarily limited to those described herein and may include any of a series of suitable effects.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a perspective view of a configuration of a secondary battery according to Modification 1.

FIG. 4 is a sectional view of a configuration of a battery device illustrated in FIG. 3.

FIG. 5 is a block diagram illustrating a configuration of an application example of the secondary battery.

### DETAILED DESCRIPTION

The present application is described below in detail including with reference to the drawings according to an embodiment.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution which is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

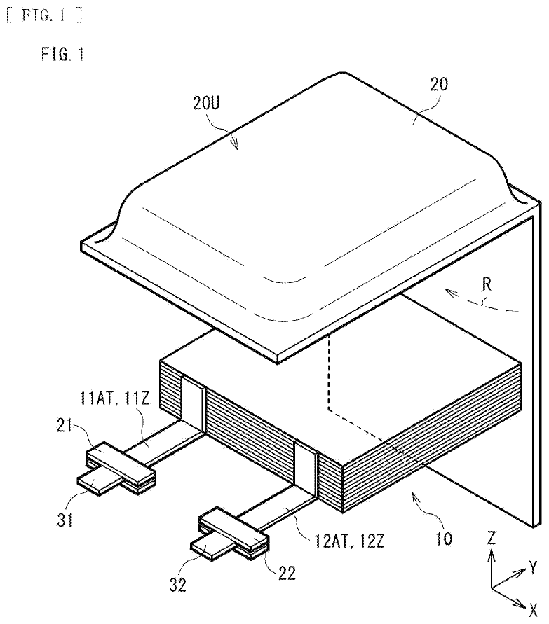

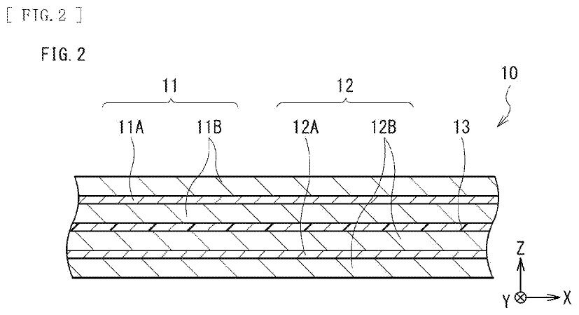

FIG. 1 illustrates a perspective configuration of the secondary battery. FIG. 2 illustrates a sectional configuration of a battery device 10 illustrated in FIG. 1. Note that FIG. 1 illustrates a state in which the battery device 10 and an outer package film 20 are separated away from each other, and FIG. 2 illustrates only a portion of the battery device 10.

As illustrated in FIG. 1, the secondary battery includes the battery device 10, the outer package film 20, a positive electrode lead 31, and a negative electrode lead 32. The secondary battery described here is a secondary battery of a laminated-film type. The secondary battery of the laminated-film type includes an outer package member having flexibility or softness, that is, the outer package film 20, to contain the battery device 10.

The outer package film 20 is a single film-shaped member and is foldable in a direction of an arrow R (a dash-dotted line), as illustrated in FIG. 1. The outer package film 20 contains the battery device 10 as described above, and thus contains the positive electrode 11, the negative electrode 12, and an electrolytic solution to be described later. The outer package film 20 has a depression part 20U to place the battery device 10 therein. The depression part 20U is a so-called deep drawn part.

Specifically, the outer package film 20 is a three-layered laminated film including a fusion-bonding layer, a metal layer, and a surface protective layer that are stacked in this order from an inner side. In a state in which the outer package film 20 is folded, outer edges of the fusion-bonding layer opposed to each other are bonded (fusion-bonded) to each other. As a result, the outer package film 20 has a pouch-shaped structure that allows the battery device 10 to be sealed therein. The fusion-bonding layer includes a polymer compound such as polypropylene. The metal layer includes a metal material such as aluminum. The surface protective layer includes a polymer compound such as nylon.

Note that the outer package film 20 is not particularly limited in configuration or the number of layers, and may be single-layered or two-layered, or may include four or more layers. In other words, the outer package film 20 is not limited to a laminated film, and may be a single-layer film.

A sealing film 21 is interposed between the outer package film 20 and the positive electrode lead 31. A sealing film 22 is interposed between the outer package film 20 and the negative electrode lead 32. The sealing films 21 and 22 are members that each prevent entry of, for example, outside air into the outer package film 20. The sealing film 21 includes one or more of polymer compounds, including polyolefin, that has adherence to the positive electrode lead 31. The sealing film 22 includes one or more of polymer compounds, including polyolefin, that has adherence to the positive electrode lead 32. Examples of the polyolefin include polyethylene, polypropylene, modified polyethylene, and modified polypropylene. Note that the sealing film 21, the sealing film 22, or both may be omitted.

As illustrated in FIGS. 1 and 2, the battery device 10 is contained inside the outer package film 20, and includes the positive electrode 11, the negative electrode 12, a separator 13, and the electrolytic solution (not illustrated). The positive electrode 11, the negative electrode 12, and the separator 13 are each impregnated with the electrolytic solution.

Here, the battery device 10 is a stacked electrode body, that is, a structure in which the positive electrode 11 and the negative electrode 12 are stacked with the separator 13 interposed therebetween. The positive electrode 11 and the negative electrode 12 are thus opposed to each other with the separator 13 interposed therebetween.

Specifically, the positive electrode 11 and the negative electrode 12 are alternately stacked with the separator 13 interposed therebetween. The battery device 10 thus includes multiple positive electrodes 11, multiple negative electrodes 12, and multiple separators 13. The number of each of the positive electrodes 11, the negative electrodes 12, and the separators 13 to be stacked is not particularly limited, and may be freely chosen.

In the battery device 10, a ratio between a capacity of the positive electrode 11 and a capacity of the negative electrode 12 is optimized. Specifically, a ratio (capacity ratio) R1 of the capacity per unit area (mAh/cm²) of the positive electrode 11 to the capacity per unit area (mAh/cm²) of the negative electrode 12 is within a range from 100% to 120% both inclusive. A reason for this is that a high energy density is obtainable. The capacity ratio R1 is calculated by R1 (%)=(capacity per unit area of positive electrode 11/capacity per unit area of negative electrode 12)×100.

In a case of determining the capacity ratio R1, a capacity C1 of the positive electrode 11 and a capacity C2 of the negative electrode 12 are each calculated, following which the capacity ratio R1 is calculated, by a procedure described below.

First, the secondary battery is disassembled to thereby collect the positive electrode 11 and the negative electrode 12.

Thereafter, a test secondary battery of a coin type is fabricated using the positive electrode 11 as a test electrode and using a lithium metal plate as a counter electrode. The positive electrode 11 includes a lithium-nickel composite oxide as a positive electrode active material, as will be described later.

Thereafter, the test secondary battery is charged and discharged to thereby measure the capacity (mAh) of the positive electrode 11. Upon charging, the secondary battery is charged with a constant current of 0.1 C until a voltage reaches 4.3 V, and is thereafter charged with the constant voltage of 4.3 V until a total charging time reaches 15 hours. Upon discharging, the secondary battery is discharged with a constant current of 0.1 C until the voltage reaches 2.5 V. Note that 0.1 C is a value of a current that causes a battery capacity (a theoretical capacity) to be completely discharged in 10 hours.

Thereafter, the capacity C1 per unit area (mAh/cm²) of the positive electrode 11 is calculated on the basis of an area (cm²) of the positive electrode 11. The capacity C1 per unit area of the positive electrode 11 is calculated by C1=capacity of positive electrode 11/area of positive electrode 11.

Thereafter, a test secondary battery of a coin type is fabricated using the negative electrode 12 as a test electrode and using a lithium metal plate as a counter electrode. The negative electrode 12 includes a lithium-titanium composite oxide as a negative electrode active material, as will be described later.

Thereafter, the test secondary battery is charged and discharged to thereby measure the capacity (mAh) of the negative electrode 12. Upon charging, the secondary battery is charged with a constant current of 0.1 C until a voltage reaches 2.7 V, and is thereafter charged with the constant voltage of 2.7 V until the total charging time reaches 15 hours. Upon discharging, the secondary battery is discharged with a constant current of 0.1 C until the battery voltage reaches 1.0 V.

Thereafter, the capacity C2 per unit area (mAh/cm²) of the negative electrode 12 is calculated on the basis of an area (cm²) of the negative electrode 12. The capacity C2 per unit area of the negative electrode 12 is calculated by C2=capacity of negative electrode 12/area of negative electrode 12.

Lastly, the capacity ratio R1 is calculated on the basis of the capacities C1 and C2. The capacity ratio R1 is calculated by R1=(capacity C1/capacity C2)×100, as described above.

The positive electrode 11 includes a positive electrode current collector 11A having two opposed surfaces, and two positive electrode active material layers 11B disposed on the respective two opposed surfaces of the positive electrode current collector 11A, as illustrated in FIG. 2. Note that the positive electrode active material layer 11B may be disposed only on one of the two opposed surfaces of the positive electrode current collector 11A.

The positive electrode current collector 11A includes one or more of electrically conductive materials including, without limitation, a metal material. Examples of the metal material include aluminum, nickel, and stainless steel. The positive electrode active material layer 11B includes one or more of positive electrode active materials into which lithium is insertable and from which lithium is extractable, and may further include, for example, a positive electrode binder and a positive electrode conductor.

Here, the positive electrode current collector 11A includes a projecting part 11AT on which the positive electrode active material layer 11B is not provided, as illustrated in FIG. 1. Accordingly, in a case where the battery device 10 includes the multiple positive electrodes 11 (multiple positive electrode current collectors 11A), the battery device 10 includes multiple projecting parts 11AT. The multiple projecting parts 11AT are joined to each other to form a single joint part 11Z having a lead shape.

The positive electrode active material includes a lithium-containing compound, and more specifically, includes one or more of lithium-nickel composite oxides. The term “lithium-nickel composite oxide” is a generic term for an oxide including lithium and nickel as constituent elements, as described above. The lithium-nickel composite oxide has a layered rock-salt crystal structure. A reason why the positive electrode active material includes the lithium-nickel composite oxide is that a high energy density is obtainable.

The lithium-nickel composite oxide is not particularly limited in kind or configuration, as long as the oxide includes lithium and nickel as constituent elements. Specifically, the lithium-nickel composite oxide includes lithium, nickel, and another element as constituent elements. The other element is one or more of elements (excluding nickel) belonging to groups 2 to 15 in the long period periodic table of elements.

More specifically, the lithium-nickel composite oxide includes one or more of compounds represented by Formula (4) below.

LiₓN_{(1-y)}M4_{y}O₂ (4)

where:
M4 is at least one of elements (excluding Ni) belonging to groups 2 to 15 in the long period periodic table of elements;
x and y satisfy 0.8≤x≤1.2 and 0≤y<1.0;
a composition of lithium differs depending on a charge and discharge state; and
x is a value in a completely discharged state.

As is apparent from Formula (4), a content of nickel in the lithium-nickel composite oxide is determined depending on a content of the other element (M4). Note that, as is apparent from a value range that y can take, the lithium-nickel composite oxide may include the other element (M4) as a constituent element, or may not include the other element (M4) as a constituent element. In this case, the content of nickel in the lithium-nickel composite oxide is not particularly limited, and may be freely chosen, as long as the lithium-nickel composite oxide includes nickel as a constituent element.

In particular, it is preferable that the content of nickel in the lithium-nickel composite oxide be sufficiently large. More specifically, a ratio (molar ratio) R3 of a number of moles of nickel to the sum of the number of moles of nickel and a number of moles of the other element (M4) is preferably 80% or greater. The molar ratio R3 is calculated by R3 (%)=[number of moles of nickel/(number of moles of nickel+number of moles of other element)]×100.

In other words, the lithium-nickel composite oxide preferably includes one or more of compounds represented by Formula (5) below. A reason for this is that a higher energy density is obtainable.

LiₓN_{(1-y)}M5_{y}O₂ (5)

where:
M5 is at least one of elements (excluding Ni) belonging to groups 2 to 15 in the long period periodic table of elements;
x and y satisfy 0.8≤x≤1.2 and 0≤y≤0.2;
a composition of lithium differs depending on a charge and discharge state; and
x is a value in a completely discharged state.

A procedure of determining the molar ratio R3 is as described below.

First, X g of a sample for analysis (the lithium-nickel composite oxide) is precisely weighed, following which the sample is put into a beaker having a capacity of 50 ml (=50 cm³). A precise weighing amount (X g) of the sample may be freely chosen. Thereafter, one stirring bar is put into the beaker, and hydrochloric acid for precise analysis having a concentration of 0.01 mol/ml (=0.01 mol/cm³) is put into the beaker with a whole pipette, following which contents of the beaker are stirred with a stirrer.

Thereafter, all of the contents are extracted with a disposable syringe, following which an extract is filtered with a 0.2-μm syringe filter. Thereafter, 2.5 ml (=2.5 cm³) of a filtrate is collected with a whole pipette, following which the filtrate is diluted with hydrochloric acid having a concentration of 0.6 mol/l (=0.6 mol/dm³). Thereafter, 1.0 ml (=1.0 cm³) of the filtrate is collected with a whole pipette, and the filtrate is put into a measuring flask having a capacity of 25 ml (=25 cm³), following which the filtrate is diluted with hydrochloric acid having a concentration of 5.0 mol/l (=5.0 mol/dm³).

Thereafter, the filtrate is subjected to elemental analysis by inductively coupled plasma (ICP) emission spectroscopy to thereby measure the content, that is, the number of moles, of each constituent element such as nickel.

Lastly, the molar ratio R3 is calculated on the basis of the number of moles of nickel and the number of moles of the other element (M4 or M5). The molar ratio R3 is calculated by R3 (%)=[number of moles of nickel/(number of moles of nickel+number of moles of other element)]×100, as described above.

Specific examples of the lithium-nickel composite oxide include LiNiO₂, LiNi_{0.70}Co_{0.30}O₂, LiNi_{0.80}Co_{0.15}Al_{0.05}O₂, LiNi_{0.82}Co_{0.14}Al_{0.04}O₂, LiNi_{0.50}Co_{0.20}Mn_{0.30}O₂, LiNi_{0.80}Co_{0.10}Al_{0.05}Mn_{0.05}O₂, LiNi_{0.80}Co_{0.20}O₂, LiNi_{0.82}Co_{0.18}O₂, LiNi_{0.85}Co_{0.15}O₂, and LiNi_{0.90}Co_{0.10}O₂. In particular, preferable examples include LiNi_{0.80}Co_{0.15}Al_{0.05}O₂, LiNi_{0.80}Co_{0.10}Al_{0.05}Mn_{0.05}O₂, LiNi_{0.80}Co_{0.20}O₂, LiNi_{0.82}Co_{0.18}O₂, LiNi_{0.85}Co_{0.15}O₂, and LiNi_{0.90}Co_{0.10}O₂ in each of which the molar ratio R3 is 80% or greater.

The positive electrode active material may further include one or more of other positive electrode active materials, that is, other lithium-containing compounds, as long as the positive electrode active material includes the lithium-nickel composite oxide described above.

The other positive electrode active material is not particularly limited in kind, and specific examples thereof include a lithium-transition-metal compound. The term “lithium-transition-metal compound” is a generic term for a compound including lithium and one or more transition metal elements as constituent elements. The lithium-transition-metal compound may further include one or more other elements. The other element is not particularly limited in kind, as long as the other element is an element other than the transition metal element. Specifically, the other element is one or more of elements belonging to groups 2 to 15 in the long period periodic table of elements. Note that the lithium-nickel composite oxide described above is excluded from the lithium-transition-metal compound described here.

The lithium-transition-metal compound is not particularly limited in kind, and specific examples thereof include an oxide, a phosphoric acid compound, a silicic acid compound, and a boric acid compound. Specific examples of the oxide include LiCoO₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

A method of forming the positive electrode active material layer 11B is not particularly limited, and specifically, one or more methods are selected from among a coating method and other methods.

The negative electrode 12 is opposed to the positive electrode 11 with the separator 13 interposed therebetween, as illustrated in FIG. 2. The negative electrode 12 includes a negative electrode current collector 12A having two opposed surfaces, and two negative electrode active material layers 12B disposed on the respective two opposed surfaces of the negative electrode current collector 12A. Note that the negative electrode active material layer 12B may be disposed only on one of the two opposed surfaces of the negative electrode current collector 12A.

The negative electrode current collector 12A includes one or more of electrically conductive materials including, without limitation, a metal material. Examples of the metal material include copper, aluminum, nickel, and stainless steel. The negative electrode active material layer 12B includes one or more of negative electrode active materials into which lithium is insertable and from which lithium is extractable, and may further include, for example, a negative electrode binder and a negative electrode conductor. Details of each of the negative electrode binder and the negative electrode conductor are similar to details of each of the positive electrode binder and the positive electrode conductor.

Here, the negative electrode current collector 12A includes a projecting part 12AT on which the negative electrode active material layer 12B is not provided, as illustrated in FIG. 1. The projecting part 12AT is disposed at a position not overlapping the projecting part 11AT. Accordingly, in a case where the battery device 10 includes the multiple negative electrodes 12 (multiple negative electrode current collectors 12A), the battery device 10 includes multiple projecting parts 12AT. The multiple projecting parts 12AT are joined to each other to form a single joint part 12Z having a lead shape.

The negative electrode active material includes one or more of lithium-titanium composite oxides. The term “lithium-titanium composite oxide” is a generic term for an oxide including lithium and titanium as constituent elements, as described above. The lithium-titanium composite oxide has a spinel crystal structure. A reason why the negative electrode active material includes the lithium-titanium composite oxide is that a decomposition reaction of the electrolytic solution in the negative electrode 12 is suppressed, and thus gas generation due to the decomposition reaction of the electrolytic solution is also suppressed.

The lithium-titanium composite oxide is not particularly limited in kind or configuration, as long as the oxide includes lithium and titanium as constituent elements. Specifically, the lithium-titanium composite oxide includes lithium, titanium, and another element as constituent elements. The other element is one or more of elements (excluding titanium) belonging to groups 2 to 15 in the long period periodic table of elements. Note that an oxide including nickel together with lithium and titanium as constituent elements shall be classified as the lithium-titanium composite oxide, not as the lithium-nickel composite oxide.

More specifically, the lithium-titanium composite oxide includes one or more of a compound represented by Formula (1) below, a compound represented by Formula (2) below, or a compound represented by Formula (3) below. M1 in Formula (1) is a metal element that is to be a divalent ion. M2 in Formula (2) is a metal element that is to be a trivalent ion. M3 in Formula (3) is a metal element that is to be a tetravalent ion. A reason for this is that a decomposition reaction of the electrolytic solution in the negative electrode 12 is sufficiently suppressed, and thus gas generation due to the decomposition reaction of the electrolytic solution is also sufficiently suppressed.

Li[LiₓM1_{(1-3x)/2}Ti_{(3+x)/2}]O₄ (1)

where:
M1 is at least one of Mg, Ca, Cu, Zn, or Sr; and
x satisfies 0≤x≤⅓.

Li[Li_{y}M2_{1-3y}Ti_{1+2y}]O₄ (2)

where:
M2 is at least one of Al, Sc, Cr, Mn, Fe, Ga, or Y; and
y satisfies 0≤y≤⅓.

Li[Li_{1/3}M3_{z}Ti_{(5/3)-z}]O₄ (3)

where:
M3 is at least one of V, Zr, or Nb; and
z satisfies 0≤z≤⅔.

As is apparent from a value range that x can take in Formula (1), the lithium-titanium composite oxide represented by Formula (1) may include the other element (M1) as a constituent element, or may not include the other element (M1) as a constituent element. As is apparent from a value range that y can take in Formula (2), the lithium-titanium composite oxide represented by Formula (2) may include the other element (M2) as a constituent element, or may not include the other element (M2) as a constituent element. As is apparent from a value range that z can take in Formula (3), the lithium-titanium composite oxide represented by Formula (3) may include the other element (M3) as a constituent element, or may not include the other element (M3) as a constituent element.

Specific examples of the lithium-titanium composite oxide represented by Formula (1) include Li_{3.75}Ti_{4.875}Mg_{0.375}O₁₂. Specific examples of the lithium-titanium composite oxide represented by Formula (2) include LiCrTiO₄. Specific examples of the lithium-titanium composite oxide represented by Formula (3) include Li₄Ti₅O₁₂ and Li₄Ti_{4.95}Nb_{0.05}O₁₂.

The negative electrode active material may further include one or more of other negative electrode active materials, as long as the negative electrode active material includes the lithium-titanium composite oxide described above.

The other negative electrode active material is not particularly limited in kind, and specific examples thereof include a carbon material and a metal-based material. Examples of the carbon material include graphitizable carbon, non-graphitizable carbon, and graphite. Examples of the graphite include natural graphite and artificial graphite. The metal-based material is a material that includes one or more elements among metal elements and metalloid elements that are each able to form an alloy with lithium. The metal element and the metalloid element are not particularly limited in kind, and specific examples thereof include silicon and tin. The metal-based material may be a simple substance, an alloy, a compound, a mixture of two or more thereof, or a material including two or more phases thereof. Note that the lithium-titanium composite oxide described above is excluded from the metal-based material described here.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, SnO_{w} (0<w≤2), SnSiO₃, LiSnO, and Mg₂Sn. Note that v of SiOᵥ may satisfy 0.2<v<1.4.

A method of forming the negative electrode active material layer 12B is not particularly limited, and specifically, one or more methods are selected from among a coating method, a vapor-phase method, a liquid-phase method, a thermal spraying method, and a firing (sintering) method.

In a case of fabricating each of the positive electrode 11 and the negative electrode 12, it is possible to adjust the capacity ratio R1 by changing a relationship between an amount of the positive electrode active material and an amount of the negative electrode active material. More specifically, in a process of fabricating each of the positive electrode 11 and the negative electrode 12, it is possible to adjust the capacity ratio R1 by changing a thickness of the negative electrode active material layer 12B while fixing a thickness of the positive electrode active material layer 11B.

The “thickness of the negative electrode active material layer 12B” described here is the total thickness of the negative electrode active material layer 12B. Accordingly, in a case where the negative electrode 12 includes the two negative electrode active material layers 12B because the negative electrode active material layer 12B is disposed on each of the two opposed surfaces of the negative electrode current collector 12A, the thickness of the negative electrode active material layer 12B is the sum of a thickness of one of the negative electrode active material layers 12B and a thickness of the other of the negative electrode active material layers 12B.

In this case, the capacity ratio R1 is within a range from 100% to 120% both inclusive, as described above. Thus, even if the thickness of the negative electrode active material layer 12B is small, a decomposition reaction of the electrolytic solution is suppressed, which suppresses gas generation due to the decomposition reaction of the electrolytic solution, as will be described later. More specifically, the thickness of the negative electrode active material layer 12B may be 130 μm or less.

The separator 13 is an insulating porous film interposed between the positive electrode 11 and the negative electrode 12 as illustrated in FIG. 2, and allows lithium ions to pass therethrough while preventing a contact between the positive electrode 11 and the negative electrode 12. The separator 13 includes one or more of polymer compounds including, without limitation, polytetrafluoroethylene, polypropylene, and polyethylene.

The electrolytic solution includes a solvent and an electrolyte salt.

The solvent includes one or more of non-aqueous solvents (organic solvents). An electrolytic solution including a non-aqueous solvent is a so-called non-aqueous electrolytic solution. Specifically, the non-aqueous solvent includes a dinitrile compound and a carboxylic acid ester.

The dinitrile compound is a chain compound having a nitrile group (—CN) at each end, thus including two nitrile groups. The dinitrile compound serves to improve oxidation resistance of the carboxylic acid ester by being used in combination with the carboxylic acid ester.

Although not particularly limited in kind, the dinitrile compound is specifically a compound in which two nitrile groups are bonded to each other via a straight-chain alkylene group. Specific examples of the dinitrile compound include malononitrile (carbon number=1), succinonitrile (carbon number=2), glutaronitrile (carbon number=3), adiponitrile (carbon number=4), pimelonitrile (carbon number=5), and suberonitrile (carbon number=6). The carbon number described above in the parenthesis is a carbon number of the alkylene group.

In particular, the carbon number of the alkylene group is preferably within a range from 2 to 4 both inclusive. Accordingly, the dinitrile compound is preferably one or more of succinonitrile, glutaronitrile, or adiponitrile. A reason for this is that, for example, solubility and compatibility of the dinitrile compound improve, and the dinitrile compound sufficiently improves the oxidation resistance of the carboxylic acid ester.

The carboxylic acid ester is a straight-chain saturated fatty acid ester. Specific examples of the carboxylic acid ester include methyl acetate, ethyl acetate, methyl propionate, ethyl propionate, propyl propionate, and ethyl trimethylacetate.

In particular, the carboxylic acid ester is preferably ethyl propionate, propyl propionate, or both. A reason for this is that a decomposition reaction of the carboxylic acid ester is sufficiently suppressed upon charging and discharging, and thus gas generation due to the decomposition reaction of the carboxylic acid ester is also sufficiently suppressed.

Note that a content of the dinitrile compound in the solvent is set to fall within a predetermined range with respect to a content of the carboxylic acid ester in the solvent. Specifically, a ratio (molar ratio) R2 of a number of moles of the dinitrile compound to a number of moles of the carboxylic acid ester is within a range from 1% to 4% both inclusive. A reason for this is that the content of the dinitrile compound is optimized with respect to the content of the carboxylic acid ester. Thus, even if the dinitrile compound and the carboxylic acid ester are used in combination, a decomposition reaction of the carboxylic acid ester is suppressed, and thus gas generation due to the decomposition reaction of the carboxylic acid ester is also suppressed. The molar ratio R2 is calculated by R2 (%)=(number of moles of dinitrile compound/number of moles of carboxylic acid ester)×100.

Although not particularly limited, the content of the carboxylic acid ester in the solvent is preferably within a range from 50 wt % to 90 wt % both inclusive in particular. A reason for this is that a decomposition reaction of the carboxylic acid ester is sufficiently suppressed upon charging and discharging, and thus gas generation due to the decomposition reaction of the carboxylic acid ester is also sufficiently suppressed.

The solvent may further include one or more of other non-aqueous solvents, as long as the solvent includes the dinitrile compound and the carboxylic acid ester described above.

Examples of the other non-aqueous solvent include esters and ethers. More specific examples of the other non-aqueous solvent include a carbonic-acid-ester-based compound and a lactone-based compound. A reason for this is that a dissociation property of the electrolyte salt improves and a high mobility of ions is obtainable.

Specifically, examples of the carbonic-acid-ester-based compound include a cyclic carbonic acid ester and a chain carbonic acid ester. Specific examples of the cyclic carbonic acid ester include ethylene carbonate and propylene carbonate. Specific examples of the chain carbonic acid ester include dimethyl carbonate, diethyl carbonate, and methyl ethyl carbonate.

Examples of the lactone-based compound include a lactone. Specific examples of the lactone include γ-butyrolactone and γ-valerolactone. Note that examples of the ethers other than the lactone-based compounds described above may include 1,2-dimethoxyethane, tetrahydrofuran, 1,3-dioxolane, and 1,4-dioxane.

Further, examples of the non-aqueous solvent may include an unsaturated cyclic carbonic acid ester, a halogenated carbonic acid ester, a sulfonic acid ester, a phosphoric acid ester, an acid anhydride, a mononitrile compound, and an isocyanate compound. A reason for this is that chemical stability of the electrolytic solution improves.

Specific examples of the unsaturated cyclic carbonic acid ester include vinylene carbonate (1,3-dioxol-2-one), vinylethylene carbonate (4-vinyl-1,3-dioxolane-2-one), and methylene ethylene carbonate (4-methylene-1,3-dioxolane-2-one). Specific examples of the halogenated carbonic acid ester include fluoroethylene carbonate (4-fluoro-1,3-dioxolane-2-one) and difluoroethylene carbonate (4,5-difluoro-1,3-dioxolane-2-one). Examples of the sulfonic acid ester include 1,3-propane sultone and 1,3-propene sultone. Specific examples of the phosphoric acid ester include trimethyl phosphate and triethyl phosphate.

Examples of the acid anhydride include a cyclic dicarboxylic acid anhydride, a cyclic disulfonic acid anhydride, and a cyclic carboxylic acid sulfonic acid anhydride. Specific examples of the cyclic dicarboxylic acid anhydride include succinic anhydride, glutaric anhydride, and maleic anhydride. Specific examples of the cyclic disulfonic acid anhydride include 1,2-ethanedisulfonic anhydride and 1,3-propanedisulfonic anhydride. Specific examples of the cyclic carboxylic acid sulfonic acid anhydride include sulfobenzoic anhydride, sulfopropionic anhydride, and sulfobutyric anhydride.

The mononitrile compound is a compound having one nitrile group. Specific examples of the mononitrile compound include acetonitrile. Specific examples of the isocyanate compound include hexamethylene diisocyanate.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium difluoro(oxalato)borate (LiBF₂(C₂O₄)), and lithium bis(oxalato)borate (LiB(C₂O₄)₂).

Although not particularly limited, a content of the electrolyte salt is specifically within a range from 0.3 mol/kg to 3.0 mol/kg both inclusive with respect to the solvent. A reason for this is that a high ionic conductivity is obtainable.

A procedure of determining a composition of the electrolytic solution, including the molar ratio R2 and the content of the carboxylic acid ester in the solvent described above, is as described below.

In a case of examining a composition of a component (the solvent) included in the electrolytic solution, the electrolytic solution is analyzed by one or more of methods including, without limitation, gas chromatography and high-performance liquid gas chromatography. Thus, for example, the kind of the solvent included in the electrolytic solution is identified.

In a case of examining a content of the component (the solvent) included in the electrolytic solution, first, the secondary battery is disassembled to thereby collect the battery device 10, following which the electrolytic solution is collected from the battery device 10. The electrolytic solution is used as a reference solution in a later process. Thereafter, the battery device 10 from which the electrolytic solution has not been collected is immersed in an organic solvent (dimethyl carbonate) for an immersion time of 24 hours. Thus, the electrolytic solution with which the battery device 10 is impregnated is extracted into the organic solvent. As a result, an electrolytic solution extract is obtained. Lastly, the electrolytic solution extract is analyzed by the gas chromatography. In this case, the electrolytic solution collected in the earlier process is used as the reference solution. In addition, a peak area of each component (each solvent included in the electrolytic solution extract) is normalized with reference to a peak area of propylene carbonate to thereby identify a remaining amount of each component. Thus, the content of the solvent included in the electrolytic solution is identified.

In a case of examining the content of the carboxylic acid ester in the solvent, the content of the carboxylic acid ester is calculated on the basis of the content of the solvent included in the electrolytic solution described above. The content of the carboxylic acid ester is calculated by: content of carboxylic acid ester (wt %)=(weight of carboxylic acid ester/weight of solvent)×100. The “weight of solvent” is the sum of weights of all solvents included in the electrolytic solution.

In a case of examining the molar ratio R3, the number of moles of the dinitrile compound and the number of moles of the carboxylic acid ester are identified on the basis of the content of the solvent (the dinitrile compound and the carboxylic acid ester) included in the electrolytic solution described above, following which the molar ratio R3 is calculated on the basis of the number of moles of the dinitrile compound and the number of moles of the carboxylic acid ester.

The positive electrode lead 31 is a positive electrode terminal coupled to the positive electrode 11 (the positive electrode current collector 11A), and includes one or more of electrically conductive materials including, without limitation, aluminum. The positive electrode lead 31 is coupled to the joint part 11Z, thus being electrically coupled to the multiple positive electrodes 11 via the joint part 11Z. A shape of the positive electrode lead 31 is not particularly limited, and specifically, one or more shapes are selected from among a thin plate shape, a meshed shape, and other shapes.

The negative electrode lead 32 is a negative electrode terminal coupled to the negative electrode 12 (the negative electrode current collector 12A), and includes one or more of electrically conductive materials including, without limitation, copper, nickel, and stainless steel. The negative electrode lead 32 is coupled to the joint part 12Z, thus being electrically coupled to the multiple negative electrodes 12 via the joint part 12Z. Details of a shape of the negative electrode lead 32 are similar to those of the shape of the positive electrode lead 31 described above.

Here, as illustrated in FIG. 1, the positive electrode lead 31 and the negative electrode lead 32 are led out in respective directions that are common to each other, from inside to outside the outer package film 20. Note that the positive electrode lead 31 and the negative electrode lead 32 may be led out in respective directions that are different from each other.

Upon charging the secondary battery, lithium is extracted from the positive electrode 11, and the extracted lithium is inserted into the negative electrode 12 via the electrolytic solution. Upon discharging the secondary battery, lithium is extracted from the negative electrode 12, and the extracted lithium is inserted into the positive electrode 11 via the electrolytic solution. Upon charging and discharging, lithium is inserted and extracted in an ionic state.

In a case of manufacturing the secondary battery, by a procedure described below, the positive electrode 11 and the negative electrode 12 are fabricated and the electrolytic solution is prepared, following which the secondary battery is fabricated using the positive electrode 11, the negative electrode 12, and the electrolytic solution. In the following, reference will be made where appropriate to FIGS. 1 and 2 which have been already described.

First, the positive electrode active material including the lithium-nickel composite oxide is mixed with, for example, the positive electrode binder and the positive electrode conductor to thereby obtain a positive electrode mixture. Thereafter, the positive electrode mixture is put into a solvent such as an organic solvent to thereby prepare a paste positive electrode mixture slurry. Lastly, the positive electrode mixture slurry is applied on each of the two opposed surfaces of the positive electrode current collector 11A, excluding the projecting part 11AT, to thereby form the positive electrode active material layer 11B. Thereafter, the positive electrode active material layer 11B may be compression-molded by means of, for example, a roll pressing machine. In this case, the positive electrode active material layer 11B may be heated. The positive electrode active material layer 11B may be compression-molded multiple times. The positive electrode active material layer 11B is thus formed on each of the two opposed surfaces of the positive electrode current collector 11A. In this manner, the positive electrode 11 is fabricated.

The negative electrode active material layer 12B is formed on each of the two opposed surfaces of the negative electrode current collector 12A by a procedure substantially similar to the fabrication procedure of the positive electrode 11 described above. Specifically, the negative electrode active material including the lithium-titanium composite oxide is mixed with, for example, the negative electrode binder and the negative electrode conductor to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on each of the two opposed surfaces of the negative electrode current collector 12A, excluding the projecting part 12AT, to thereby form the negative electrode active material layer 12B. Thereafter, the negative electrode active material layer 12B may be compression-molded. The negative electrode active material layer 12B is thus formed on each of the two opposed surfaces of the negative electrode current collector 12A. In this manner, the negative electrode 12 is fabricated.

Note that, in the case of fabricating the negative electrode 12, the thickness of the negative electrode active material layer 12B is adjusted to make the capacity ratio R1 fall within a range from 100% to 120% both inclusive.

A component such as the electrolyte salt is put into the solvent including the carboxylic acid ester, following which another solvent (the dinitrile compound) is added to the solvent. The component such as the electrolyte salt is thereby dispersed or dissolved in the solvent. As a result, the electrolytic solution is prepared.

Note that, in a case of preparing the electrolytic solution, respective addition amounts of the dinitrile compound and the carboxylic acid ester are adjusted to make the molar ratio R2 fall within a range from 1% to 4% both inclusive.

First, the positive electrode 11 including the projecting part 11AT and the negative electrode 12 including the projecting part 12AT are alternately stacked with the separator 13 interposed therebetween to thereby fabricate a stacked body. The stacked body has a configuration similar to that of the battery device 10 except that the positive electrode 11, the negative electrode 12, and the separator 13 are each not impregnated with the electrolytic solution.

Thereafter, the multiple projecting parts 11AT are joined to each other by a method such as a welding method to form the joint part 11Z, and the multiple projecting parts 12AT are joined to each other by a method such as a welding method to form the joint part 12Z. Thereafter, the positive electrode lead 31 is coupled to the joint part 11Z by a method such as a welding method, and the negative electrode lead 32 is coupled to the joint part 12Z by a method such as a welding method.

Thereafter, the stacked body is placed inside the depression part 20U, following which the outer package film 20 (fusion-bonding layer/metal layer/surface protective layer) is folded to thereby cause portions of the outer package film 20 to be opposed to each other. Thereafter, outer edges of two sides of the outer package film 20 (the fusion-bonding layer) opposed to each other are bonded to each other by a method such as a thermal-fusion-bonding method to thereby contain the stacked body in the pouch-shaped outer package film 20.

Lastly, the electrolytic solution is injected into the pouch-shaped outer package film 20, following which the outer edges of the remaining one side of the outer package film 20 (the fusion-bonding layer) are bonded to each other by a method such as a thermal-fusion-bonding method. In this case, the sealing film 21 is interposed between the outer package film 20 and the positive electrode lead 31, and the sealing film 22 is interposed between the outer package film 20 and the negative electrode lead 32. The stacked body is thereby impregnated with the electrolytic solution. Thus, the battery device 10 which is the stacked electrode body is fabricated. In this manner, the battery device 10 is sealed in the pouch-shaped outer package film 20. As a result, the secondary battery is assembled.

The assembled secondary battery is charged and discharged. Various conditions including, without limitation, an environment temperature, the number of times of charging and discharging (i.e., the number of cycles), and charging and discharging conditions may be freely set. A film is thereby formed on a surface of, for example, the negative electrode 12. This allows the secondary battery to be in an electrochemically stable state. As a result, the secondary battery using the outer package film 20, i.e., the secondary battery of the laminated-film type is completed.

According to the secondary battery, the positive electrode 11 includes the lithium-nickel composite oxide, the negative electrode 12 includes the lithium-titanium composite oxide, and the electrolytic solution includes the dinitrile compound and the carboxylic acid ester. In addition, the capacity ratio R1 related to the capacity of the positive electrode 11 and the capacity of the negative electrode 12 is within a range from 100% to 120% both inclusive, and the molar ratio R2 related to the number of moles of the dinitrile compound and the number of moles of the carboxylic acid ester is within a range from 1% to 4% both inclusive.

In this case, firstly, because the electrolytic solution includes both the dinitrile compound and the carboxylic acid ester, the dinitrile compound improves oxidation-reduction resistance of the carboxylic acid ester. This greatly widens a potential window on the oxidation side, as compared with a case where the electrolytic solution includes only the carboxylic acid ester without including the dinitrile compound. Thus, even if the lithium-nickel composite oxide having a high property of oxidizing the electrolytic solution is used as the positive electrode active material, a decomposition reaction of the electrolytic solution (in particular, the carboxylic acid ester) is suppressed upon charging and discharging, which suppresses gas generation due to the decomposition reaction of the electrolytic solution in the positive electrode 11.

Secondly, owing to the decomposition reaction of the electrolytic solution being suppressed in the positive electrode 11, even if the lithium-titanium composite oxide is used as the negative electrode active material, formation of a by-product with high reducibility due to the decomposition reaction of the electrolytic solution in the positive electrode 11 is suppressed. Thus, a reduction reaction of the by-product in the negative electrode 12 is suppressed, which suppresses gas generation due to the reduction reaction of the by-product.

Thirdly, because the molar ratio R2 is within the above-described range, the dinitrile compound selectively coordinates to titanium in the lithium-titanium composite oxide to an extent that movement of lithium ions (a Li/Li⁺ charge transfer reaction) is not inhibited, at an interface between the negative electrode 12 (the lithium-titanium composite oxide) and the electrolytic solution. Thus, the dinitrile compound serves as a protective film that suppresses a reduction reaction of the electrolytic solution at a potential of 1.5 V or less versus a lithium reference electrode. This suppresses gas generation due to the reduction reaction of the electrolytic solution even if the capacity ratio R1 is 100% or greater.

Fourthly, owing to the dinitrile compound serving as the protective film, the negative electrode 12 may have a small thickness. This makes a concentration distribution of the electrolytic solution uniform inside the negative electrode 12 even upon large-current charging, which makes it easier for lithium ions to be inserted into and extracted from the negative electrode 12.

Based upon the above, even if the positive electrode 11 includes the lithium-nickel composite oxide and the negative electrode 12 includes the lithium-titanium composite oxide, a high energy density is obtained owing to the capacity ratio R1 being within the above-described range, and lithium-ion entry performance improves while swelling of the secondary battery is suppressed owing to the molar ratio R2 being within the above-described range. This makes it possible to obtain a superior swelling characteristic and a superior charge characteristic while securing the energy density.

In particular, the lithium-nickel composite oxide may include lithium, nickel, and another element as constituent elements, and the molar ratio R3 may be 80% or greater. This makes it possible to obtain a higher energy density. Accordingly, it is possible to achieve higher effects.

The lithium-titanium composite oxide may include one or more of the compound represented by Formula (1), the compound represented by Formula (2), or the compound represented by Formula (3). This sufficiently suppresses the swelling of the secondary battery. Accordingly, it is possible to achieve higher effects.

The dinitrile compound may include, without limitation, succinonitrile, and the carboxylic acid ester may include, without limitation, ethyl propionate. This sufficiently suppresses the swelling of the secondary battery. Accordingly, it is possible to achieve higher effects. In this case, in particular, even if ethyl propionate which more easily generates gas due to a decomposition reaction than propyl propionate while having a higher ionic conductivity than propyl propionate is used, gas generation is suppressed by, for example, succinonitrile. This makes it possible to achieve both improvement of the lithium-ion entry performance and suppression of the swelling of the secondary battery.

The solvent of the electrolytic solution may include the carboxylic acid ester, and the content of the carboxylic acid ester in the solvent may be within a range from 50 wt % to 90 wt % both inclusive. Thus, a decomposition reaction of the carboxylic acid ester is sufficiently suppressed upon charging and discharging, and thus gas generation due to the decomposition reaction of the carboxylic acid ester is also sufficiently suppressed. In other words, even if a large amount of the carboxylic acid ester (having a content within a range from 50 wt % to 90 wt % both inclusive in the solvent) is used, the gas generation due to the decomposition reaction of the carboxylic acid ester is performed by the dinitrile compound, which prevents the secondary battery from easily swelling. This sufficiently suppresses the swelling of the secondary battery. Accordingly, it is possible to achieve higher effects.

In the battery device 10, the positive electrode 11 and the negative electrode 12 may be alternately stacked with the separator 13 interposed therebetween. Thus, in a process of manufacturing the battery device 10, the electrolytic solution is supplied to the stacked body from four directions. This facilitates impregnation of the stacked body with the electrolytic solution even if a viscosity of the electrolytic solution increases due to combined use of the dinitrile compound and the carboxylic acid ester. The battery device 10 thus improves in electrolytic solution retainability, which results in further improvement of the charge characteristic. Accordingly, it is possible to achieve higher effects. In this case, an electrolytic solution injection time for the stacked body shortens in a process of manufacturing the secondary battery, making it possible to achieve higher effects also in terms of manufacture.

The secondary battery may include the outer package film 20 having flexibility, and the battery device 10 (the positive electrode 11, the negative electrode 12, and the electrolytic solution) may be contained inside the outer package film 20. This effectively prevents the secondary battery from easily swelling even if the outer package film 20 which easily causes noticeable swelling is used. Accordingly, it is possible to achieve higher effects. In addition, using the outer package film 20 makes it possible to further increase the energy density and also to achieve cost reduction of the secondary battery.

The secondary battery may include a lithium-ion secondary battery. This makes it possible to obtain a sufficient battery capacity stably through the use of insertion and extraction of lithium. Accordingly, it is possible to achieve higher effects.

Next, a description is given of modifications of the above-described secondary battery. The configuration of the secondary battery is appropriately modifiable as described below. Note that any two or more of the following series of modifications may be combined.

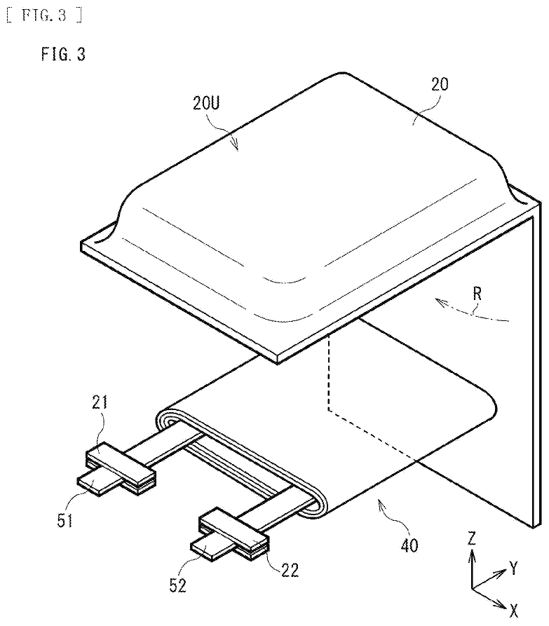

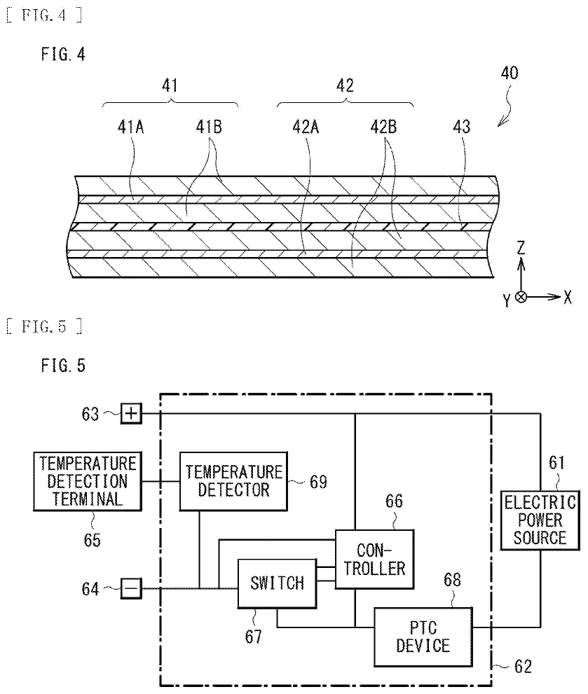

The battery device 10 which is the stacked electrode body is used in FIGS. 1 and 2. However, a battery device 40 which is a wound electrode body may be used instead of the battery device 10 which is the stacked electrode body, as illustrated in FIG. 3 corresponding to FIG. 1, and FIG. 4 corresponding to FIG. 2.

The secondary battery of the laminated-film type illustrated in FIGS. 3 and 4 has a configuration similar to that of the secondary battery of the laminated-film type illustrated in FIGS. 1 and 2 except that the battery device 40 (a positive electrode 41, a negative electrode 42, and a separator 43), a positive electrode lead 51, and a negative electrode lead 52 are included instead of the battery device 10 (the positive electrode 11, the negative electrode 12, and the separator 13), the positive electrode lead 31, and the negative electrode lead 32.

The positive electrode 41, the negative electrode 42, the separator 43, the positive electrode lead 51, and the negative electrode lead 52 have configurations similar to the configurations of the positive electrode 11, the negative electrode 12, the separator 13, the positive electrode lead 31, and the negative electrode lead 32, respectively, except the following points.

In the battery device 40, the positive electrode 41 and the negative electrode 42 are wound with the separator 43 interposed therebetween. More specifically, the positive electrode 41 and the negative electrode 42 are stacked with the separator 43 interposed therebetween, and the stack of the positive electrode 41, the negative electrode 42, and the separator 43 is wound about a winding axis. The winding axis is a virtual axis extending in a Y-axis direction. Accordingly, the positive electrode 41 and the negative electrode 42 are opposed to each other with the separator 43 interposed therebetween.

The positive electrode 41 includes a positive electrode current collector 41A and a positive electrode active material layer 41B, and the negative electrode 42 includes a negative electrode current collector 42A and a negative electrode active material layer 42B. The positive electrode 41, the negative electrode 42, and the separator 43 are each impregnated with the electrolytic solution.

Here, the battery device 40 has an elongated three-dimensional shape. In other words, a section of the battery device 40 intersecting the winding axis, that is, a section of the battery device 40 along an XZ plane, has an elongated shape defined by a major axis and a minor axis, and more specifically, has an elongated, generally elliptical shape. The major axis is a virtual axis that extends in an X-axis direction and has a relatively large length. The minor axis is a virtual axis that extends in a Z-axis direction intersecting the X-axis direction and has a relatively small length.

The positive electrode lead 51 is coupled to the positive electrode 11 (the positive electrode current collector 11A), and the negative electrode lead 52 is coupled to the negative electrode 12 (the negative electrode current collector 12A). Here, the number of the positive electrode leads 51 is one, and the number of the negative electrode leads 52 is one.

Note that the number of the positive electrode leads 51 is not particularly limited, and may be two or more. In particular, if the number of the positive electrode leads 51 is two or more, the secondary battery decreases in electrical resistance. The description given here in relation to the number of the positive electrode leads 51 also applies to the number of the negative electrode leads 52. Accordingly, the number of the negative electrode leads 52 may be two or more, without being limited to one.

A method of manufacturing the secondary battery of the laminated-film type illustrated in FIGS. 3 and 4 is substantially similar to the method of manufacturing the secondary battery of the laminated-film type illustrated in FIGS. 1 and 2, except that the battery device 40 is fabricated instead of the battery device 10 and that the positive electrode lead 51 and the negative electrode lead 52 are used instead of the positive electrode lead 31 and the negative electrode lead 32.

In a case of fabricating the battery device 40, first, the positive electrode active material layer 41B is formed on each of both sides of the positive electrode current collector 41A to thereby fabricate the positive electrode 41, and the negative electrode active material layer 42B is formed on each of both sides of the negative electrode current collector 42A to thereby fabricate the negative electrode 42. Thereafter, the positive electrode lead 51 is coupled to the positive electrode 41 (the positive electrode current collector 41A) by a method such as a welding method, and the negative electrode lead 52 is coupled to the negative electrode 42 (the negative electrode current collector 42A) by a method such as a welding method.

Thereafter, the positive electrode 41 and the negative electrode 42 are stacked on each other with the separator 43 interposed therebetween, following which the stack of the positive electrode 41, the negative electrode 42, and the separator 43 is wound to thereby fabricate a wound body. The wound body has a configuration similar to that of the battery device 40 except that the positive electrode 41, the negative electrode 42, and the separator 43 are each not impregnated with the electrolytic solution. Thereafter, the wound body is pressed by means of, for example, a pressing machine to thereby shape the wound body into an elongated shape.

Lastly, the electrolytic solution is injected into the pouch-shaped outer package film 20 containing the wound body, following which the outer package film 20 is sealed. The wound body is thereby impregnated with the electrolytic solution. Thus, the battery device 40 is fabricated.

In the battery device 40, the positive electrode 41 includes the lithium-nickel composite oxide, the negative electrode 42 includes the lithium-titanium composite oxide, the electrolytic solution includes the dinitrile compound and the carboxylic acid ester, the capacity ratio R1 is within a range from 100% to 120% both inclusive, and the molar ratio R2 is within a range from 1% to 4% both inclusive. Thus, in a case where the battery device 40 is used, it is also possible to obtain effects similar to the effects obtained in a case where the battery device 10 is used.

To shorten a time taken for the process of manufacturing the secondary battery (the electrolytic solution injection time), it is preferable to use the battery device 10 which is the stacked electrode body rather than the battery device 40 which is the wound electrode body. A reason for this is that the electrolytic solution is supplied to the wound body from two directions (some directions around the wound body) in a process of fabricating the battery device 40 which is the wound electrode body, whereas the electrolytic solution is supplied to the stacked body from four directions (all directions around the stacked body) in the process of manufacturing the battery device 10 which is the stacked electrode body. Thus, in the case of using the battery device 10, a speed of impregnation with the electrolytic solution improves, which shortens the time taken for the process of manufacturing the secondary battery, as compared with the case of using the battery device 40.

Although not specifically illustrated here, the outer package member that contains, for example, the positive electrode 11, the negative electrode 12, and the electrolytic solution is not particularly limited in kind. Accordingly, for example, a metal can which is an outer package member having stiffness may be used instead of the outer package film 20 which is the outer package member having flexibility. In this case also, similar effects are obtainable.

Note that an outer package member such as the metal can having stiffness has a property of not deforming easily by nature, unlike the outer package film 20 having flexibility. Thus, in a case where the outer package member such as the metal can is used, the secondary battery is inherently prevented from easily swelling. This may prevent noticeable swelling of the secondary battery as compared with the case where the outer package film 20 is used.

The separator 13 which is a porous film is used. However, although not specifically illustrated here, a separator of a stacked type including a polymer compound layer may be used instead of the separator 13 which is the porous film.

Specifically, the separator of the stacked type includes the porous film having two opposed surfaces, and a polymer compound layer disposed on one of or each of the two opposed surfaces of the porous film. A reason for this is that adherence of the separator to each of the positive electrode 11 and the negative electrode 12 improves to suppress the occurrence of misalignment of the battery device 10. This helps to prevent the secondary battery from easily swelling even if, for example, a decomposition reaction of the electrolytic solution occurs. The polymer compound layer includes a polymer compound such as polyvinylidene difluoride which has superior physical strength and is electrochemically stable.

Note that the porous film, the polymer compound layer, or both may each include one or more kinds of insulating particles. A reason for this is that such insulating particles dissipate heat upon heat generation by the secondary battery, thus improving safety or heat resistance of the secondary battery. Examples of the insulating particles include inorganic particles and resin particles. Specific examples of the inorganic particles include particles of aluminum oxide, aluminum nitride, boehmite, silicon oxide, titanium oxide, magnesium oxide, and zirconium oxide. Specific examples of the resin particles include particles of acrylic resin and styrene resin.

In a case of fabricating the separator of the stacked type, a precursor solution including, without limitation, the polymer compound and an organic solvent is prepared and thereafter the precursor solution is applied on one of or each of the two opposed surfaces of the porous film. In another example, the porous film may be immersed in the precursor solution. In this case, insulating particles may be added to the precursor solution on an as-needed basis.

Similar effects are obtainable also in the case where the separator of the stacked type is used, as lithium ions are movable between the positive electrode 11 and the negative electrode 12. Although a detailed description is omitted here, needless to say, the separator of the stacked type including the polymer compound layer may be used instead of the separator 43 which is a porous film.

The electrolytic solution which is a liquid electrolyte is used. However, although not specifically illustrated here, an electrolyte layer which is a gel electrolyte may be used instead of the electrolytic solution.

In the battery device 10 including the electrolyte layer, the positive electrode 11 and the negative electrode 12 are alternately stacked with the separator 13 and the electrolyte layer interposed therebetween. The electrolyte layer is interposed between the positive electrode 11 and the separator 13, and between the negative electrode 12 and the separator 13.

Specifically, the electrolyte layer includes a polymer compound together with the electrolytic solution. The electrolytic solution is held by the polymer compound in the electrolyte layer. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, without limitation, the electrolytic solution, the polymer compound, and an organic solvent is prepared and thereafter the precursor solution is applied on one or both sides of the positive electrode 11 and one or both sides of the negative electrode 12.

Similar effects are obtainable also in the case where the electrolyte layer is used, as lithium ions are movable between the positive electrode 11 and the negative electrode 12 via the electrolyte layer. Although a detailed description is omitted here, needless to say, the electrolyte layer may be applied to the battery device 40 instead of the battery device 10.

Next, a description is given of applications (application examples) of the above-described secondary battery.

The applications of the secondary battery are not particularly limited as long as they are, for example, machines, equipment, instruments, apparatuses, or systems (an assembly of a plurality of pieces of equipment, for example) in which the secondary battery is usable mainly as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specific examples of the applications of the secondary battery include: electronic equipment including portable electronic equipment; portable life appliances; apparatuses for data storage; electric power tools; battery packs to be mounted as detachable power sources on, for example, laptop personal computers; medical electronic equipment; electric vehicles; and electric power storage systems. Examples of the electronic equipment include video cameras, digital still cameras, mobile phones, laptop personal computers, cordless phones, headphone stereos, portable radios, portable televisions, and portable information terminals. Examples of the portable life appliances include electric shavers. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems for accumulation of electric power for a situation such as emergency. In these applications, one secondary battery or a plurality of secondary batteries may be used.

In particular, the battery pack is effectively applied to relatively large-sized equipment, etc., including an electric vehicle, an electric power storage system, and an electric power tool. The battery pack may include a single battery, or may include an assembled battery, as will be described later. The electric vehicle is a vehicle that operates (travels) using the secondary battery as a driving power source, and may be an automobile that is additionally provided with a driving source other than the secondary battery as described above, such as a hybrid automobile. The electric power storage system is a system that uses the secondary battery as an electric power storage source. An electric power storage system for home use accumulates electric power in the secondary battery which is an electric power storage source, and the accumulated electric power may thus be utilized for using, for example, home appliances.

One of application examples of the secondary battery will now be described in detail. The configuration of the application example described below is merely an example, and is appropriately modifiable.

FIG. 5 illustrates a block configuration of a battery pack. The battery pack described here is a simple battery pack (a so-called soft pack) including one secondary battery, and is to be mounted on, for example, electronic equipment typified by a smartphone.

As illustrated in FIG. 5, the battery pack includes an electric power source 61 and a circuit board 62. The circuit board 62 is coupled to the electric power source 61, and includes a positive electrode terminal 63, a negative electrode terminal 64, and a temperature detection terminal 65 (a so-called T terminal).

The electric power source 61 includes one secondary battery. The secondary battery has a positive electrode lead coupled to the positive electrode terminal 63 and a negative electrode lead coupled to the negative electrode terminal 64. The electric power source 61 is couplable to outside via the positive electrode terminal 63 and the negative electrode terminal 64, and is thus chargeable and dischargeable via the positive electrode terminal 63 and the negative electrode terminal 64. The circuit board 62 includes a controller 66, a switch 67, a thermosensitive resistive device (a positive temperature coefficient (PTC) device) 68, and a temperature detector 69. However, the PTC device 68 may be omitted.

The controller 66 includes, for example, a central processing unit (CPU) and a memory, and controls an overall operation of the battery pack. The controller 66 detects and controls a use state of the electric power source 61 on an as-needed basis.

If a voltage of the electric power source 61 (the secondary battery) reaches an overcharge detection voltage or an overdischarge detection voltage, the controller 66 turns off the switch 67. This prevents a charging current from flowing into a current path of the electric power source 61. In addition, if a large current flows upon charging or discharging, the controller 66 turns off the switch 67 to block the charging current. The overcharge detection voltage and the overdischarge detection voltage are not particularly limited. For example, the overcharge detection voltage is 4.2 V±0.05 V and the overdischarge detection voltage is 2.4 V±0.1 V.

The switch 67 includes, for example, a charge control switch, a discharge control switch, a charging diode, and a discharging diode. The switch 67 performs switching between coupling and decoupling between the electric power source 61 and external equipment in accordance with an instruction from the controller 66. The switch 67 includes, for example, a metal-oxide-semiconductor field-effect transistor (MOSFET) including a metal-oxide semiconductor. The charging and discharging currents are detected on the basis of an ON-resistance of the switch 67.

The temperature detector 69 includes a temperature detection device such as a thermistor. The temperature detector 69 measures a temperature of the electric power source 61 using the temperature detection terminal 65, and outputs a result of the temperature measurement to the controller 66. The result of the temperature measurement to be obtained by the temperature detector 69 is used, for example, in a case where the controller 66 performs charge/discharge control upon abnormal heat generation or in a case where the controller 66 performs a correction process upon calculating a remaining capacity.

### EXAMPLES

A description is provided below of Examples of the present technology according to an embodiment.

### Experiment Examples 1 to 52

Secondary batteries were fabricated, following which the secondary batteries were evaluated for performance, as described below.

### [Fabrication of Secondary Battery]

Secondary batteries of the laminated-film type illustrated in FIGS. 1 and 2 were fabricated by the following procedure.

### (Fabrication of Positive Electrode)

First, 98 parts by mass of the positive electrode active material (LiNi_{0.82}Co_{0.14}Al_{0.04}O₂ (LNCAO) which is the lithium-nickel composite oxide) was mixed with 1 part by mass of the positive electrode binder (polyvinylidene difluoride) and 1 part by mass of the positive electrode conductor (carbon black) to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on each of the two opposed surfaces of the positive electrode current collector 11A (an aluminum foil having a thickness of 12 μm), excluding the projecting part 11AT, by means of a coating apparatus, following which the applied positive electrode mixture slurry was dried to thereby form the positive electrode active material layer 11B. Lastly, the positive electrode active material layer 11B was compression-molded by means of a roll pressing machine. The positive electrode active material layer 11B was thus disposed on each of the two opposed surfaces of the positive electrode current collector 11A. In this manner, the positive electrode 11 was fabricated.

In particular, in the case of fabricating the positive electrode 11, a plurality of kinds of lithium-nickel composite oxides that differed from each other in content of nickel were used, as indicated in Tables 1 to 4, to thereby vary the molar ratio R3 related to the number of moles of nickel.

### (Fabrication of Negative Electrode)

First, 98 parts by mass of the negative electrode active material (Li₄Ti₅O₁₂ (LTO) which is the lithium-titanium composite oxide) was mixed with 1 part by mass of the negative electrode binder (polyvinylidene difluoride) and 1 part by mass of the negative electrode conductor (carbon black) to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on each of the two opposed surfaces of the negative electrode current collector 12A (a copper foil having a thickness of 15 μm), excluding the projecting part 12AT, by means of a coating apparatus, following which the applied negative electrode mixture slurry was dried to thereby form the negative electrode active material layer 12B. Lastly, the negative electrode active material layer 12B was compression-molded by means of a roll pressing machine. The negative electrode active material layer 12B was thus disposed on each of the two opposed surfaces of the negative electrode current collector 12A. In this manner, the negative electrode 12 was fabricated.

In particular, in the case of fabricating the negative electrode 12, the thickness (μm) of the negative electrode active material layer 12B was changed depending on an application amount of the negative electrode mixture slurry, as indicated in Tables 1 to 4, to thereby vary the capacity ratio R1 related to the capacity of the positive electrode 11 and the capacity of the negative electrode 12.

For comparison, the negative electrode 12 was fabricated by a similar procedure except that a carbon material (graphite) was used as the negative electrode active material instead of the lithium-titanium composite oxide. A procedure of determining the capacity ratio R1 in the case where the carbon material was used as the negative electrode active material was similar to the procedure of determining the capacity ratio R1 in the case where the lithium-titanium composite oxide was used as the negative electrode active material, except that an upper-limit voltage at the time of charging was changed to 0 V and a lower-limit voltage at the time of discharging was changed to 1.5 V in a case of charging and discharging the test secondary battery to determine the capacity of the negative electrode 12.

### (Preparation of Electrolytic Solution)

First, the solvent was prepared. Used as the solvent was a mixture of propylene carbonate which is a cyclic carbonic acid ester and the carboxylic acid ester. The kind of the carboxylic acid ester and the content (wt %) of the carboxylic acid ester in the solvent were as given in Tables 1 to 4.

Used as the carboxylic acid ester were methyl propionate (MtPr), ethyl propionate (EtPr), propyl propionate (PrPr), methyl acetate (MtAc), and ethyl acetate (EtAc).

Thereafter, the electrolyte salt (LiPF₆ which is a lithium salt) was added to the solvent, following which the solvent was stirred. In this case, the content of the electrolyte salt with respect to the solvent was set to 1 mol/kg.

Lastly, the dinitrile compound, another solvent (vinylene carbonate which is an unsaturated cyclic carbonic acid ester), and another electrolyte salt (LiBF₄ which is a lithium salt) were added to the solvent including the electrolyte salt, following which the solvent including the electrolyte salt was stirred.

Used as the dinitrile compound were malononitrile (MN), succinonitrile (SN), glutaronitrile (GN), adiponitrile (AN), pimelonitrile (PN), and suberonitrile (SBN).

Thus, the dinitrile compound, the other solvent, and the other electrolyte salt were each dissolved or dispersed in the solvent including the electrolyte salt. As a result, the electrolytic solution was prepared. In this case, a content of the other solvent in the electrolytic solution was set to 0.5 wt %, and a content of the other electrolyte salt in the electrolytic solution was set to 1 wt %.

In particular, in a case of preparing the electrolytic solution, the addition amount of the dinitrile compound was changed, as indicated in Tables 1 to 4, to thereby vary the molar ratio R2 related to the number of moles of the carboxylic acid ester and the number of moles of the dinitrile compound.

For comparison, the electrolytic solution was prepared by a similar procedure except that a chain carbonic acid ester was used instead of the carboxylic acid ester. Diethyl carbonate (DEC) and ethyl methyl carbonate (EMC) were used as the chain carbonic acid ester. In Table 4, for convenience, the chain carbonic acid ester (DEC and EMC) is indicated in the “Carboxylic acid ester” column. Note that an asterisk (*) is placed before each of DEC and EMC to clarify that each of DEC and EMC is not the carboxylic acid ester.

In addition, for comparison, the electrolytic solution was prepared by a similar procedure except that the dinitrile compound was not used.

### (Assembly of Secondary Battery)

First, the positive electrode 11 and the negative electrode 12 were alternately stacked with the separator 13 (a fine-porous polyethylene film having a thickness of 15 μm) interposed therebetween to thereby fabricate the stacked body.

Thereafter, the multiple projecting parts 11AT were welded to each other to form the joint part 11Z, and the multiple projecting parts 12AT were welded to each other to form the joint part 12Z. Thereafter, the positive electrode lead 31 including aluminum was welded to the joint part 11Z, and the negative electrode lead 32 including copper was welded to the joint part 12Z.

Thereafter, the stacked body was placed inside the depression part 20U of the outer package film 20. As the outer package film 20, a laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order. In Tables 1 to 4, “Laminated” listed in the “Outer package member” column indicates the use of the outer package film 20 (the laminated film) as the outer package member. Thereafter, the outer package film 20 was folded in such a manner as to sandwich the stacked body and to have the fusion-bonding layer on the inner side, following which the outer edges of two sides of the outer package film 20 (the fusion-bonding layer) were thermal-fusion-bonded to each other to thereby allow the stacked body to be contained inside the pouch-shaped outer package film 20.

Lastly, the electrolytic solution was injected into the pouch-shaped outer package film 20 and thereafter, the outer edges of the remaining one side of the outer package film 20 (the fusion-bonding layer) were thermal-fusion-bonded to each other in a reduced-pressure environment. In this case, the sealing film 21 (a polypropylene film having a thickness of 5 μm) was interposed between the outer package film 20 and the positive electrode lead 31, and the sealing film 22 (a polypropylene film having a thickness of 5 μm) was interposed between the outer package film 20 and the negative electrode lead 32. The stacked body was thereby impregnated with the electrolytic solution. Thus, the battery device 10 was fabricated. In Tables 1 to 4, “Stacked” listed in the “Battery device (Device structure)” column indicates the use of the battery device 10 which is the stacked electrode body.

In this manner, the battery device 10 was sealed in the outer package film 20, and the secondary battery was thus assembled.

### (Stabilization Process)

The secondary battery was charged and discharged for one cycle in an ambient temperature environment (at a temperature of 25° C.). Upon charging, the secondary battery was charged with a constant current of 0.01 C until a voltage reached 2.7 V. Upon discharging, the secondary battery was discharged with a constant current of 0.2 C. Note that 0.01 C is a value of a current that causes the battery capacity (the theoretical capacity) to be completely discharged in 100 hours, and 0.2 C is a value of a current that causes the battery capacity to be completely discharged in 5 hours.

As a result, a film was formed on, for example, the surface of the negative electrode 12 to stabilize the state of the secondary battery. Thus, the secondary battery of the laminated-film type including the outer package film 20 having flexibility was completed.

[Fabrication of Other Secondary Batteries]

Other secondary batteries were also fabricated by the following procedure.

### (Change of Device Structure of Battery Device)

Secondary batteries of the laminated-film type illustrated in FIGS. 3 and 4 were fabricated by a similar procedure except that the battery device 40 which is the wound electrode body was used instead of the battery device 10 which is the stacked electrode body and that the positive electrode lead 51 and the negative electrode lead 52 were used instead of the positive electrode lead 31 and the negative electrode lead 32.

The battery device 40 was fabricated by the following procedure. First, the positive electrode lead 51 including aluminum was welded to the positive electrode 41 (the positive electrode current collector 41A), and the negative electrode lead 52 including copper was welded to the negative electrode 42 (the negative electrode current collector 42A). Thereafter, the positive electrode 41 and the negative electrode 42 were stacked on each other with the separator 43 (a fine-porous polyethylene film having a thickness of 15 μm) interposed therebetween, following which the stack of the positive electrode 41, the negative electrode 42, and the separator 43 was wound to thereby fabricate the wound body. Thereafter, the wound body was pressed by means of a pressing machine, and was thereby shaped into an elongated shape. Lastly, the electrolytic solution was injected into the pouch-shaped outer package film 20 containing the wound body to thereby impregnate the wound body with the electrolytic solution. In Tables 1 to 4, “Wound” listed in the “Battery device (Device structure)” column indicates the use of the battery device 40 which is the wound electrode body.

### (Change of Outer Package Member)

In addition, secondary batteries of a prismatic type were fabricated by a similar procedure except that the metal can having stiffness was used as the outer package member instead of the outer package film 20 having flexibility. In Tables 1 to 4, “Metal” listed in the “Outer package member” column indicates the use of the metal can as the outer package member. The metal can had an elongated three-dimensional shape substantially similar to that of the outer package film 20 illustrated in FIG. 1. The metal can had a wall thickness of 0.15 mm.

The secondary battery was assembled by the following procedure. First, the elongated wound body was placed inside a container member including stainless steel and having a three-dimensional shape of an elongated rectangular prism with one end open and another end closed. Thereafter, the electrolytic solution was injected into the container member to thereby impregnate the wound body with the electrolytic solution. The wound body was thereby impregnated with the electrolytic solution. Thus, the battery device 40 was fabricated. Lastly, a cover member including stainless steel was welded to the one end of the container member. Thus, the battery device 40 was sealed in the metal can including the container member and the cover member.

Evaluation of the performance (the swelling characteristic, the charge characteristic, and an energy characteristic) of the secondary batteries revealed the results presented in Tables 1 to 4. A procedure of evaluating each characteristic was as described below.

### (Swelling Characteristic)

First, a thickness (a pre-storage thickness) of the secondary battery was measured in an ambient temperature environment. Thereafter, the secondary battery was charged, and the secondary battery in a charged state was stored in a high-temperature environment (at a temperature of 60° C.) for a storage time of 1 month, following which the thickness (a post-storage thickness) of the secondary battery was measured again in the same environment. Upon charging, the secondary battery was charged with a constant current of 0.01 C until a voltage reached 2.7 V. Lastly, swelling rate (%)=[(post-storage thickness−pre-storage thickness)/pre-storage thickness]×100 was calculated.

Note that, in a case where an amount of increase in the thickness of the secondary battery after the storage was a slight amount because the metal can was used as the outer package member, a volume change of the secondary battery was measured by the Archimedes' method, following which the thickness of the secondary battery after the storage was calculated on the basis of a measurement result of the volume change.

### (Charge Characteristic)

First, the secondary battery was charged and discharged in an ambient temperature environment to thereby measure the battery capacity. Upon charging, the secondary battery was charged with a constant current of 0.5 C until a voltage reached an upper-limit voltage. The upper-limit voltage was set to 2.7 V in a case where the lithium-titanium composite oxide was used as the negative electrode active material, and to 4.2 V in a case where the carbon material was used as the negative electrode active material. Upon discharging, the secondary battery was discharged with a constant current of 0.2 C until the voltage reached a lower-limit voltage. The lower-limit voltage was set to 1.0 V in a case where the lithium-titanium composite oxide was used as the negative electrode active material, and to 2.5 V in a case where the carbon material was used as the negative electrode active material. Note that 0.5 C is a value of a current that causes the battery capacity to be completely discharged in 2 hours.

Thereafter, the secondary battery was charged in the same environment to thereby measure a charge capacity. Upon charging, the secondary battery was charged with a constant current of 6 C until the voltage reached the upper-limit voltage. Details of the upper-limit voltage were as described above. Note that 6 C is a value of a current that causes the battery capacity to be completely discharged in ⅙ hours.

Lastly, state of charge (%)=(charge capacity/battery capacity)×100 was calculated. The state of charge represents the charge capacity in percent in a case where the battery capacity is regarded as 100%.

### (Capacity Characteristic)

First, the secondary battery was charged and discharged in an ambient temperature environment to thereby measure an average discharge voltage together with the battery capacity. Charging and discharging conditions were similar to those when the battery capacity was measured in the case where the charge characteristic was examined. Thereafter, an electric energy (Wh) was calculated on the basis of the battery capacity and the average discharge voltage. Lastly, an energy density per unit weight (E density, Wh/kg) was calculated on the basis of a mass (kg) of the secondary battery.

### (Status of Injection)

Here, to examine a status of injection of the electrolytic solution in the process of manufacturing the secondary battery, a time taken to impregnate each of the stacked body and the wound body with the electrolytic solution was further measured. In this case, after the injection of the electrolytic solution, a time (the injection time (min)) taken for the thickness of the secondary battery to reach a constant thickness as a result of the impregnation with the electrolytic solution was measured.

TABLE 1

| | | | Positive | | Negative | | | | | | | | | | |
|---|---|---|---|---|---|---|---|---|---|---|---|---|---|---|---|
| | | | electrode | | electrode | | | | | | | | | | |
| Exper- | | Battery | Positive | | Negative | | | | | | | | State | | |
| iment | Outer | device | electrode | | electrode | Thick- | | Electrolytic solution | | | | Swelling | of | E | Injection |
| exam- | package | Device | active | R3 | active | ness | R1 | Dinitrile | Carboxylic | R2 | Content | rate | charge | density | time |
| ple | member | structure | material | (%) | material | (μm) | (%) | compound | acid ester | (%) | (wt %) | (%) | (%) | (Wh/kg) | (min) |
| 1 | Laminated | Stacked | LNCAO | 82 | LTO | 120 | 110 | SN | PrPr | 1 | 75 | 1.5 | 95.5 | 100 | 34 |
| 2 | Laminated | Stacked | LNCAO | 82 | LTO | 120 | 110 | SN | PrPr | 2 | 75 | 1.3 | 95.3 | 100 | 35 |
| 3 | Laminated | Stacked | LNCAO | 82 | LTO | 120 | 110 | SN | PrPr | 3 | 75 | 1.4 | 94.2 | 100 | 35 |
| 4 | Laminated | Stacked | LNCAO | 82 | LTO | 120 | 110 | SN | PrPr | 4 | 75 | 1.7 | 93.8 | 100 | 36 |
| 5 | Laminated | Stacked | LNCAO | 82 | LTO | 130 | 100 | SN | PrPr | 1 | 75 | 1.6 | 92.9 | 101 | 37 |
| 6 | Laminated | Stacked | LNCAO | 82 | LTO | 110 | 120 | SN | PrPr | 1 | 75 | 1.8 | 95.5 | 98 | 37 |
| 7 | Laminated | Stacked | LNCAO | 50 | LTO | 120 | 110 | SN | PrPr | 1 | 75 | 1.7 | 93.8 | 85 | 38 |
| 8 | Laminated | Stacked | LNCAO | 60 | LTO | 120 | 110 | SN | PrPr | 1 | 75 | 1.6 | 94.5 | 90 | 36 |
| 9 | Laminated | Stacked | LNCAO | 80 | LTO | 120 | 110 | SN | PrPr | 1 | 75 | 1.6 | 94.9 | 97 | 34 |
| 10 | Laminated | Stacked | LNCAO | 86 | LTO | 120 | 110 | SN | PrPr | 1 | 75 | 1.9 | 93.8 | 102 | 34 |
| 11 | Laminated | Stacked | LNCAO | 93 | LTO | 120 | 110 | SN | PrPr | 1 | 75 | 2.9 | 92.1 | 104 | 32 |
| 12 | Laminated | Stacked | LNCAO | 82 | LTO | 120 | 110 | MN | PrPr | 1 | 75 | 2.0 | 94.2 | 100 | 33 |
| 13 | Laminated | Stacked | LNCAO | 82 | LTO | 120 | 110 | GN | PrPr | 1 | 75 | 1.9 | 95.1 | 100 | 34 |
| 14 | Laminated | Stacked | LNCAO | 82 | LTO | 120 | 110 | AN | PrPr | 1 | 75 | 1.8 | 94.8 | 100 | 34 |
| 15 | Laminated | Stacked | LNCAO | 82 | LTO | 120 | 110 | PN | PrPr | 1 | 75 | 2.4 | 94.3 | 100 | 34 |

TABLE 2

| | | | Positive | | Negative | | | | | | | | | | |
|---|---|---|---|---|---|---|---|---|---|---|---|---|---|---|---|
| | | | electrode | | electrode | | | | | | | | | | |
| Exper- | | Battery | Positive | | Negative | | | | | | | | State | | |
| iment | Outer | device | electrode | | electrode | Thick- | | Electrolytic solution | | | | Swelling | of | E | Injection |
| exam- | package | Device | active | R3 | active | ness | R1 | Dinitrile | Carboxylic | R2 | Content | rate | charge | density | time |
| ple | member | structure | material | (%) | material | (μm) | (%) | compound | acid ester | (%) | (wt %) | (%) | (%) | (Wh/kg) | (min) |
| 16 | Laminated | Stacked | LNCAO | 82 | LTO | 120 | 110 | SBN | PrPr | 1 | 75 | 2.2 | 94.6 | 100 | 35 |
| 17 | Laminated | Stacked | LNCAO | 82 | LTO | 120 | 110 | SN | MtPr | 1 | 75 | 3.5 | 95.1 | 100 | 28 |
| 18 | Laminated | Stacked | LNCAO | 82 | LTO | 120 | 110 | SN | EtPr | 1 | 75 | 2.1 | 95.5 | 100 | 30 |
| 19 | Laminated | Stacked | LNCAO | 82 | LTO | 120 | 110 | SN | MtAc | 1 | 75 | 3.4 | 94.7 | 100 | 28 |
| 20 | Laminated | Stacked | LNCAO | 82 | LTO | 120 | 110 | SN | EtAc | 1 | 75 | 2.8 | 94.9 | 100 | 30 |
| 21 | Laminated | Stacked | LNCAO | 82 | LTO | 120 | 110 | SN | PrPr | 1 | 50 | 1.1 | 92.9 | 100 | 40 |
| 22 | Laminated | Stacked | LNCAO | 82 | LTO | 120 | 110 | SN | PrPr | 1 | 90 | 2.1 | 95.8 | 100 | 30 |
| 23 | Laminated | Wound | LNCAO | 82 | LTO | 120 | 110 | SN | PrPr | 1 | 75 | 1.6 | 85.4 | 99 | 78 |
| 24 | Metal | Wound | LNCAO | 82 | LTO | 120 | 110 | SN | PrPr | 1 | 75 | 0.2 | 85.9 | 87 | 85 |

TABLE 3

| | | | Positive | | Negative | | | | | | | | | | |
|---|---|---|---|---|---|---|---|---|---|---|---|---|---|---|---|
| | | | electrode | | electrode | | | | | | | | | | |
| Exper- | | Battery | Positive | | Negative | | | Electrolytic solution | | | | | State | | |
| iment | Outer | device | electrode | | electrode | Thick- | | | Carboxylic | | | Swelling | of | E | Injection |
| exam- | package | Device | active | R3 | active | ness | R1 | Dinitrile | acid | R2 | Content | rate | charge | density | time |
| ple | member | structure | material | (%) | material | (μm) | (%) | compound | ester | (%) | (wt %) | (%) | (%) | (Wh/kg) | (min) |
| 25 | Laminated | Stacked | LNCAO | 82 | LTO | 120 | 110 | — | PrPr | 0 | 75 | 12.8 | 93.2 | 100 | 30 |
| 26 | Laminated | Stacked | LNCAO | 82 | LTO | 120 | 110 | SN | PrPr | 5 | 75 | 1.7 | 89.8 | 100 | 36 |
| 27 | Laminated | Stacked | LNCAO | 82 | LTO | 120 | 110 | SN | PrPr | 10 | 75 | 1.6 | 80.5 | 99 | 38 |
| 28 | Laminated | Stacked | LNCAO | 50 | LTO | 145 | 90 | — | PrPr | 0 | 75 | 8.8 | 88.5 | 100 | 35 |
| 29 | Laminated | Stacked | LNCAO | 60 | LTO | 130 | 100 | — | PrPr | 0 | 75 | 10.5 | 93.1 | 101 | 32 |
| 30 | Laminated | Stacked | LNCAO | 80 | LTO | 110 | 120 | — | PrPr | 0 | 75 | 14.3 | 93.7 | 98 | 30 |
| 31 | Laminated | Stacked | LNCAO | 86 | LTO | 100 | 130 | — | PrPr | 0 | 75 | 14.8 | 93.2 | 94 | 28 |
| 32 | Laminated | Stacked | LNCAO | 93 | LTO | 145 | 90 | SN | PrPr | 1 | 75 | 1.7 | 88.8 | 100 | 38 |
| 33 | Laminated | Stacked | LNCAO | 93 | LTO | 100 | 130 | SN | PrPr | 1 | 75 | 2.0 | 93.9 | 94 | 35 |
| 34 | Laminated | Stacked | LNCAO | 50 | LTO | 120 | 110 | — | PrPr | 0 | 75 | 8.9 | 93.8 | 85 | 35 |
| 35 | Laminated | Stacked | LNCAO | 60 | LTO | 120 | 110 | — | PrPr | 0 | 75 | 9.8 | 94.0 | 90 | 34 |
| 36 | Laminated | Stacked | LNCAO | 80 | LTO | 120 | 110 | — | PrPr | 0 | 75 | 12.5 | 94.1 | 97 | 30 |
| 37 | Laminated | Stacked | LNCAO | 86 | LTO | 120 | 110 | — | PrPr | 0 | 75 | 16.6 | 87.7 | 102 | 30 |
| 38 | Laminated | Stacked | LNCAO | 93 | LTO | 120 | 110 | — | PrPr | 0 | 75 | 21.0 | 82.2 | 104 | 28 |

TABLE 4

| | | | Positive | | Negative | | | | | | | | | | |
|---|---|---|---|---|---|---|---|---|---|---|---|---|---|---|---|
| | | | electrode | | electrode | | | | | | | | | | |
| Exper- | | Battery | Positive | | Negative | | | | | | | | State | | |
| iment | Outer | device | electrode | | electrode | Thick- | | Electrolytic solution | | | | Swelling | of | E | Injection |
| exam- | package | Device | active | R3 | active | ness | R1 | Dinitrile | Carboxylic | R2 | Content | rate | charge | density | time |
| ple | member | structure | material | (%) | material | (μm) | (%) | compound | acid ester | (%) | (wt %) | (%) | (%) | (Wh/kg) | (min) |
| 39 | Laminated | Stacked | LNCAO | 82 | LTO | 120 | 110 | — | MtPr | 0 | 75 | 13.9 | 93.9 | 100 | 26 |
| 40 | Laminated | Stacked | LNCAO | 82 | LTO | 120 | 110 | — | EtPr | 0 | 75 | 12.9 | 93.8 | 100 | 28 |
| 41 | Laminated | Stacked | LNCAO | 82 | LTO | 120 | 110 | — | MtAc | 0 | 75 | 14.5 | 94.2 | 100 | 26 |
| 42 | Laminated | Stacked | LNCAO | 82 | LTO | 120 | 110 | — | EtAc | 0 | 75 | 13.8 | 94.1 | 100 | 28 |
| 43 | Laminated | Stacked | LNCAO | 82 | LTO | 120 | 110 | — | *DEC | 0 | 75 | 13.5 | 93.8 | 100 | 35 |
| 44 | Laminated | Stacked | LNCAO | 82 | LTO | 120 | 110 | — | *EMC | 0 | 75 | 14.2 | 93.9 | 100 | 30 |
| 45 | Laminated | Stacked | LNCAO | 82 | LTO | 120 | 110 | SN | *DEC | 1 | 75 | 9.6 | 92.9 | 100 | 38 |
| 46 | Laminated | Stacked | LNCAO | 82 | LTO | 120 | 110 | SN | *EMC | 1 | 75 | 10.1 | 93.5 | 100 | 34 |
| 47 | Laminated | Stacked | LNCAO | 82 | LTO | 120 | 110 | — | PrPr | 0 | 50 | 10.1 | 90.5 | 100 | 40 |
| 48 | Laminated | Stacked | LNCAO | 82 | LTO | 120 | 110 | — | PrPr | 0 | 90 | 20.1 | 93.9 | 100 | 30 |
| 49 | Laminated | Wound | LNCAO | 82 | LTO | 120 | 110 | — | PrPr | 0 | 75 | 12.7 | 82.8 | 99 | 65 |
| 50 | Metal | Wound | LNCAO | 82 | LTO | 120 | 110 | — | PrPr | 0 | 75 | 7.0 | 85.8 | 87 | 80 |
| 51 | Laminated | Stacked | LNCAO | 82 | Graphite | 120 | 110 | — | PrPr | 0 | 75 | 5.2 | 84.3 | 200 | 35 |
| 52 | Laminated | Stacked | LNCAO | 82 | Graphite | 120 | 110 | SN | PrPr | 1 | 75 | 4.8 | 84.2 | 200 | 38 |

As indicated in Tables 1 to 4, in the secondary battery in which the positive electrode 11 included the lithium-nickel composite oxide, the negative electrode 12 included the lithium-titanium composite oxide, and the electrolytic solution included the carboxylic acid ester, each of the swelling characteristic, the charge characteristic, and the energy characteristic varied depending on the capacity ratio R1 and the molar ratio R2.

Specifically, in a case where two conditions that the capacity ratio R1 is within a range from 100% to 120% both inclusive and the molar ratio R2 is within a range from 1% to 4% both inclusive were satisfied simultaneously (Experiment examples 1 to 24), the swelling rate significantly decreased and the state of charge significantly increased, while the energy density per unit weight was secured, as compared with a case where the two conditions were not satisfied simultaneously (Experiment examples 25 to 50).

In particular, in the case where the two conditions described above were satisfied simultaneously, the following tendencies were obtained.

Firstly, in a case where the molar ratio R3 was 80% or greater (Experiment examples 1 and 9 to 11), the energy density per unit weight further increased, while each of the swelling rate and the state of charge was substantially maintained, as compared with a case where the molar ratio R3 was less than 80% (Experiment examples 7 and 8).

Secondly, in a case where the dinitrile compound was, for example, succinonitrile (Experiment examples 1, 13, and 14), the swelling rate further decreased and the state of charge further increased, while the energy density per unit weight was maintained, as compared with a case where the dinitrile compound was, for example, malononitrile (Experiment examples 12, 15, and 16).

Thirdly, in a case where the carboxylic acid ester was, for example, ethyl propionate (Experiment examples 1 and 18), the swelling rate further decreased and the state of charge further increased, while the energy density per unit weight was maintained, as compared with a case where the carboxylic acid ester was, for example, methyl propionate (Experiment examples 17, 19, and 20).

Fourthly, if the content of the carboxylic acid ester in the solvent was within a range from 50 wt % to 90 wt % both inclusive (Experiment examples 1, 21, and 22), the swelling rate sufficiently decreased and the state of charge sufficiently increased, while a sufficient energy density per unit weight was obtained.

Fifthly, in a case where the battery device 10 which is the stacked electrode body was used (Experiment example 1), the injection time was greatly shortened, as compared with a case where the battery device 40 which is the wound electrode body was used (Experiment example 23). Thus, in the former case, the swelling rate further decreased, the state of charge further increased, and the energy density per unit weight also further increased, as compared with the latter case.

Sixthly, in a case where the metal can having stiffness was used as the outer package member (Experiment example 24), the swelling rate hardly changed even if the two conditions described above were satisfied simultaneously. In contrast, in a case where the outer package film 20 having flexibility was used as the outer package member (Experiment example 1), the swelling rate changed as a result of the two conditions being satisfied simultaneously, but the swelling rate was sufficiently suppressed.

In addition, the following tendencies were also obtained in the case where the two conditions described above were satisfied simultaneously.

In a case where the solvent included the chain carbonic acid ester (Experiment examples 43 to 46), a sufficient energy density per unit weight was obtained and the state of charge sufficiently increased, but the swelling rate greatly increased. In this case, in particular, the swelling rate did not sufficiently decrease even if the two conditions described above were satisfied simultaneously.

In contrast, in a case where the solvent included the carboxylic acid ester (Experiment examples 1 and 25), the state of charge increased and the swelling rate decreased, while the energy density per unit weight was maintained, as compared with the case where the solvent included the chain carbonic acid ester. In this case, in particular, the swelling rate greatly decreased if the two conditions were satisfied.

In addition, in a case where the carbon material was used as the negative electrode active material (Experiment examples 51 and 52), the energy density per unit weight significantly increased, but the swelling rate increased and the state of charge decreased. In this case, in particular, the swelling rate hardly decreased even if the two conditions described above were satisfied simultaneously.

In contrast, in a case where the lithium-titanium composite oxide was used as the negative electrode active material (Experiment examples 1 and 25), the energy density per unit weight decreased, but the swelling rate decreased and the state of charge increased, as compared with the case where the carbon material was used as the negative electrode active material. In this case, in particular, a sufficient energy density per unit weight was obtained, and the swelling rate greatly decreased if the two conditions were satisfied.

Based upon the results presented in Tables 1 to 4, if the positive electrode 11 included the lithium-nickel composite oxide, the negative electrode 12 included the lithium-titanium composite oxide, the electrolytic solution included the dinitrile compound and the carboxylic acid ester, the capacity ratio R1 was within a range from 100% to 120% both inclusive, and the molar ratio R2 was within a range from 1% to 4% both inclusive, all of the swelling characteristic, the charge characteristic, and the energy characteristic were improved. Accordingly, in the secondary battery, a superior swelling characteristic and a superior charge characteristic were obtained while the energy density was secured.

Although the present technology has been described herein, the configuration of the present technology is not limited thereto and is modifiable in a variety of suitable ways.

Specifically, although the description has been given of the case where the secondary battery has a battery structure of the laminated-film type or the prismatic type, the battery structure is not particularly limited. Alternatively, the battery structure of the secondary battery may be of any other type, such as a cylindrical type, a coin type, or a button type.

Further, although the description has been given of the case where the device structure of the battery device is of the stacked type (the stacked electrode body) or the wound type (the wound electrode body), the device structure of the battery device is not limited to a particular structure. Alternatively, the battery device may have a device structure of any other type, such as a zigzag folded type in which the electrodes (the positive electrode and the negative electrode) are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

1. A secondary battery comprising:
a positive electrode including a lithium-nickel composite oxide;
a negative electrode including a lithium-titanium composite oxide; and
an electrolytic solution including a dinitrile compound and a carboxylic acid ester, wherein
a ratio of a capacity per unit area of the positive electrode to a capacity per unit area of the negative electrode is greater than or equal to 100 percent and less than or equal to 120 percent, and
a ratio of a number of moles of the dinitrile compound to a number of moles of the carboxylic acid ester is greater than or equal to 1 percent and less than or equal to 4 percent.

2. The secondary battery according to claim 1, wherein
the lithium-nickel composite oxide includes lithium, nickel, and another element as constituent elements, the other element being at least one of elements belonging to groups 2 to 15 in the long period periodic table of elements, excluding nickel, and
a ratio of a number of moles of the nickel to a sum of the number of moles of the nickel and a number of moles of the other element is 80 percent or greater.

3. The secondary battery according to claim 1, wherein the lithium-titanium composite oxide includes at least one of a compound represented by Formula (1) below, a compound represented by Formula (2) below, or a compound represented by Formula (3) below,
Li[LiₓM1_{(1-3x)/2}Ti_{(3+x)/2}]O₄ (1)
where
M1 is at least one of Mg, Ca, Cu, Zn, or Sr, and
x satisfies 0≤x≤⅓,
Li[Li_{y}M2_{1-3y}Ti_{1+2y}]O₄ (2)
where
M2 is at least one of Al, Sc, Cr, Mn, Fe, Ga, or Y, and
y satisfies 0≤y≤⅓,
Li[Li_{1/3}M3_{z}Ti_{(5/3)-z}]O₄ (3)
where
M3 is at least one of V, Zr, or Nb, and
z satisfies 0≤z≤⅔.

4. The secondary battery according to claim 1, wherein
the dinitrile compound includes at least one of succinonitrile, glutaronitrile, or adiponitrile, and
the carboxylic acid ester includes ethyl propionate, propyl propionate, or both.

5. The secondary battery according to claim 1, wherein
the electrolytic solution includes a solvent,
the solvent includes the carboxylic acid ester, and
a content of the carboxylic acid ester in the solvent is greater than or equal to 50 weight percent and less than or equal to 90 weight percent.

6. The secondary battery according to claim 1, further comprising a separator interposed between the positive electrode and the negative electrode, wherein
the positive electrode and the negative electrode are alternately stacked with the separator interposed therebetween.

7. The secondary battery according to claim 1, further comprising an outer package member having flexibility and containing the positive electrode, the negative electrode, and the electrolytic solution.

8. The secondary battery according to claim 1, wherein the secondary battery comprises a lithium-ion secondary battery.
